(19) United States
(12) Patent Application Publication
(10) Pub. No.: US 2016/0370836 A1
(43) Pub. Date: Dec. 22, 2016

(54) STANDBY POWER CONTROLLER COMMUNICATIONS

(71) Applicant: EMBERTEC PTY LTD, Dulwich SA (AU)

(72) Inventor: Domenico Gelonese, Dulwich (AU)

(21) Appl. No.: 15/184,326

(22) Filed: Jun. 16, 2016

(30) Foreign Application Priority Data
Jun. 18, 2015 (AU) 2015902340

(51) Int. Cl. G06F 1/26; G06F 1/32

(52) U.S. Cl. CPC G06F 1/266; G06F 1/3287; G06F 1/3209

(57) ABSTRACT

A standby power controller includes a power sensor providing a power sensor signal representing power drawn through the standby power controller, and which can be processed to determine whether devices connected to the standby power controller are in a low power standby mode; a user presence/involvement sensor providing a user presence/involvement signal indicative of whether a television powered by the standby power controller is in an active standby mode; and a switch which removes television power when an active standby or low power standby state is determined. A separate power measurement device provides an overall usage signal representing overall power drawn by at least a part of the standby power controller's household. The power sensor signal and overall usage signal can be processed to disaggregate the power use of at least one device whose power use is included in the overall usage signal, but not in the power sensor signal.

### FIELD OF THE INVENTION

This invention relates to a standby power controller having a data communication capability.

### BACKGROUND OF THE INVENTION

The following references to and descriptions of prior products or other matter are not intended to be and are not to be construed as statements or admissions of common general knowledge in the art. In particular, the following prior art discussion does not relate to what is commonly or well known by the person skilled in the art, but may assist in the understanding of the inventiveness of the present invention, of which the identification of pertinent prior matter is but one part.

There is currently world-wide concern about the level of use of electrical energy for both domestic and commercial uses. In part this concern is based on the greenhouse gas production associated with the generation of electrical energy, and the contribution of that greenhouse gas to anthropogenic global warming. There is also a concern for the capital cost involved in building the electricity generating plants and electricity distribution networks required to generate and distribute an increasing amount of electricity.

A significant contributor to the energy use of households are so-called “plug loads”. These are the devices which are powered by plugging on to a general power outlet (GPO), which may also be called a wall socket. These plug loads include audio visual equipment, including multiple devices such as televisions, television decoders, television recorders and sound equipment now found in virtually all homes. Plug loads also include semi-fixed small appliances and lamps. Plug loads are typically not moved around within a house. Their usage is often highly discretionary, and highly dependent upon individual households' lifestyle choices.

Efforts have been made to reduce or control the use of energy by television receivers and associated audio visual equipment, in particular with the use of standby power controllers, and these have met with considerable success. Attempts have been made to add improved functionality to the basic standby power controller to improve power saving and also to enhance user experience. User experience is important, as one of the greatest barriers to power saving by standby power controllers is user adoption and continued use. Features which address these problems often require user interaction or more sophisticated controls.

Installation of energy saving devices which control plug loads, such as standby power controllers and automated and semi-automated plug connected power switches, has often been incentivized by energy utilities or government agencies. These bodies seek assurances that the anticipated energy savings from such installations are actually achieved and are achieved on an ongoing basis.

Information concerning the usage patterns and energy usage of plug loads is difficult to obtain, but has become very important to energy supply and distribution utilities, as well as to householders.

Information regarding plug loads (and household loads in general) may be found by disaggregation of energy data from a household, that is, by analyzing the total energy usage of a household to determine usage by each or particular appliances. However, the number of appliances with overlapping usage in a household makes this challenging.

### SUMMARY OF THE INVENTION

A preferred feature of the invention relates to a standby power controller including a power sensor which measures power drawn through the standby power controller, and which outputs the result as a power sensor signal (e.g., as power sensor data). A processor determines from the power sensor signal that devices connected to the standby power controller are in a low power standby power state. A user presence/involvement sensor provides a user presence/involvement signal (e.g., data indicative of user presence or activity) to the processor, which also determines if a television connected to the standby power controller is in an active standby mode or a low power standby mode. A switch operates to remove power from the television when an active standby or low power standby state is determined. A communication module communicates the power sensor signal to an external communications unit for transmission to an external monitoring agent.

Preferably, the user presence/involvement sensor detects use of a remote control, wherein the remote control controls audio visual equipment which is powered through the standby power controller.

Preferably, the user presence/involvement sensor is an infra-red detector for detecting use of an infra-red remote control device, or a radio frequency radiation detector for detecting use of a radio frequency remote control device.

The user presence/involvement sensor can also or instead include a motion sensor.

In an exemplary version of the invention, the user presence/involvement sensor includes both a motion sensor and a remote control use sensor.

Preferably, the standby power controller further includes a wireless transceiver for communication with a Smartmeter.

Preferably, the communications module is a wi-fi communications transceiver adapted to communicate with a household wi-fi router, or a low power cellular telephony communications transceiver.

The invention can also involve an energy usage monitoring system including a standby power controller, and also including a power measurement device which outputs an overall usage signal (e.g., data representing overall power usage) and communicates the overall power usage signal to an external monitoring agent. The overall usage signal provides a measure of overall power drawn by at least a part of the household where the standby power controller is installed.

Preferably, the power measurement device is a meter which measures power use by the household to facilitate charging for energy use supplied by a utility.

Preferably, the power measurement device is a meter which is independent of any meter which measures power use by the household to facilitate charging for energy supplied by a utility.

Preferably, the invention further includes a processor for processing the power sensor signal with the overall usage signal to disaggregate the power use of at least one appliance whose power use is included in the overall usage signal, but not in the power sensor signal.

The invention preferably provides a method for disaggregation of energy use by a household utilizing a standby power controller, wherein the method includes receiving an overall usage signal from a power measurement device (such a signal being a measure of overall power drawn by a household where the standby power controller is installed); receiving a power sensor signal describing the energy use of at least one appliance powered through the standby power controller; and processing the power sensor signal with the overall usage signal to disaggregate the power use of at least one appliance whose power use is included in the overall usage signal, but not in the power sensor signal.

The invention may also or alternatively involve a standby power controller including a power sensor adapted to sense power drawn by one or more appliances connected via plug to the standby power controller,

further including a presence sensor which detects the presence of a user in the vicinity of the standby power controller, wherein the standby power controller is adapted to withdraw power from one or more of the appliances when no user presence is detected,

and further including a communications unit adapted to communicate a signal representing the sensed power to an external entity.

Preferably, the presence sensor is a remote control usage detector which determines that no user is present when no remote control usage is detected for a period.

Preferably, the remote control usage detector detects one or more of infra-red radiation and radio frequency radiation.

Preferably, the remote control usage detector detects RF4CE transmissions for a remote control unit associated with an appliance connected to the standby power controller.

### BRIEF DESCRIPTION OF THE DRAWINGS

The invention will now be described with reference to exemplary versions of the invention in connection with the accompanying drawings, in which:

FIG. 1 is a representation of a standby power controller incorporating the invention.

FIG. 2 is a physical block diagram of the operation of a standby power controller incorporating the invention.

FIG. 3 is functional block diagram of an exemplary version of the invention.

### DETAILED DESCRIPTION OF EXEMPLARY VERSIONS OF THE INVENTION

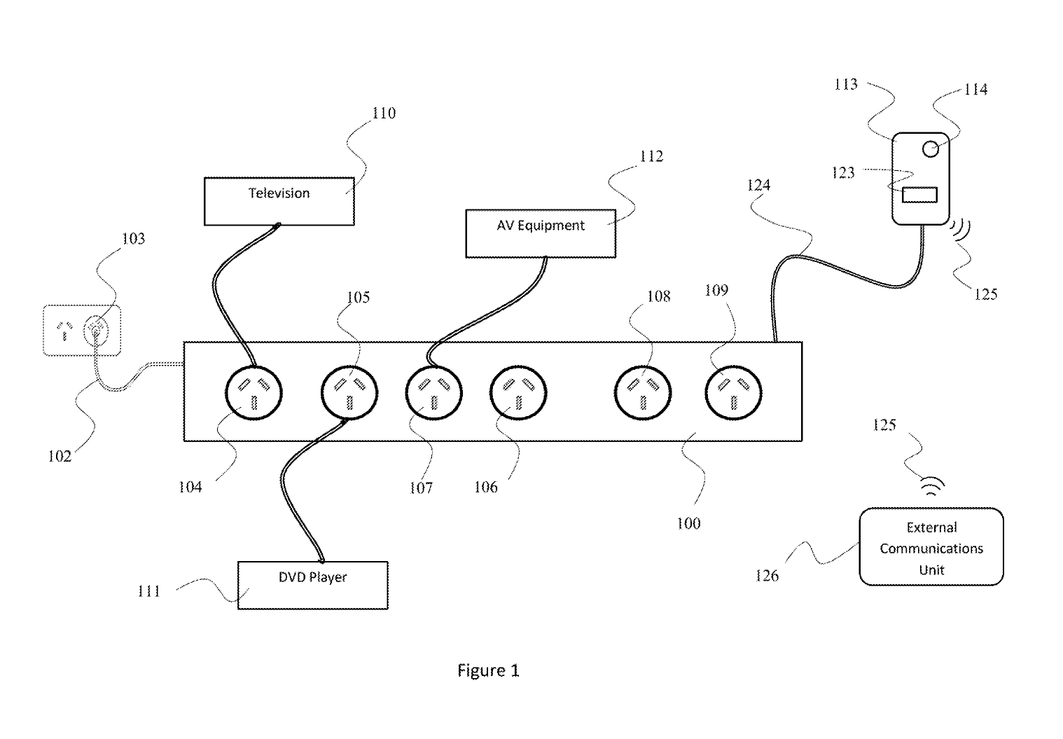

FIG. 1 is a general representation of an installation including a standby power controller (SPC) including the invention, and is illustrative only. It is not intended to limit the number or configuration of continually powered or switched or monitored main outlets, or of communication interfaces or other functional modules.

FIG. 1 shows a representation of a standby power controller (SPC) 100 including an exemplary version of the current invention. An SPC is a device which controls the flow of electrical power to one or more connected appliances such that when one or more, or a particular one, of the connected appliances is in a “standby” state where it is not being used, the electrical power supply to one, all or selected ones of the connected appliances is interrupted by the SPC.

The standby power controller (SPC) 100 receives electrical power from a General Purpose Outlet 103, via power cord 102. The SPC 100 includes Monitored and Controlled Outlets 104, 105, 106, and 107. The SPC also includes Uncontrolled Outlets 108, 109. In general, any number of Monitored and Controlled Outlets and Uncontrolled Outlets may be provided. In some versions of the invention, the Uncontrolled Outlet(s) may be absent.

Monitored and Controlled Outlet 104 supplies electrical power to a television 110 or other electronic display (e.g., a monitor). Further Monitored and Controlled Outlets 105, 106 may provide electrical power to other audio-visual equipment, for example, a DVD player 111 and audio equipment 112. In an exemplary version of the standby power controller (SPC) 100 having only one Monitored and Controlled Outlet, multiple devices may be powered from the one outlet using a powerstrip. In any version of the invention, multiple devices may be powered from one Monitored and Controlled outlet using a powerstrip.

The standby power controller (SPC) 100 includes a Sensing and Communications Unit 113. In a preferred version of the invention, this unit is in data communication with the body of the SPC 100 via cable 124, which may also provide power to the Sensing and Communications Unit 113. The Sensing and Communications Unit 113 also includes a remote communication means 123, which in the illustrated version of the invention is provided by a wi-fi transceiver. The cable 124 may be a fixed connection or may be plug connected at one or both ends. In a further version of the invention, the Sensing and Communications Unit 113 may be integrated with the body of the SPC 100. In further versions of the invention, the remote communication means 123 may be provided by a wireless transceiver using any convenient wireless protocol, including without limitation, Bluetooth, zigbee and RF4CE.

Modern television sets and other audio visual equipment, when turned “off” by the remote control, enter a “low power standby” state, in which energy is still consumed, although at a significantly lower level that when the device is fully “on”. When the television is in this standby state it is not in use, and the power supply to it may be cut to save energy.

It is also the case that television sets may be left on for extended periods when no user is viewing the screen. This may happen, for example, when a user falls asleep in front of the television, or when a user, particularly a child or a teenager, simply leaves the vicinity of the television without turning the television off; or when a user, still present, ceases to be interested in the television, but does not switch it “off”. This state may be termed “active standby”. In this state the television is not in use, and the power supply to it may be cut to save energy.

In order to save energy, the standby power controller (SPC) 100 operates to remove the power supply from Monitored and Controlled Outlet 104, and hence from the attached television 110, whenever the television 110 is detected to be in a standby state.

The standby power controller (SPC) 100 may detect that the television 110 has entered either an active standby state or a low power standby state by any convenient means or combination of means. For example, the SPC 100 may include a power sensor adapted to sense the power drawn through a Monitored and Controlled Outlet 104. The power sensor detects characteristics of the power flow through the Outlet 104. When the characteristic is such as to indicate that the television 110 is in a standby mode, the power to the Monitored and Controlled Outlet 104, and hence to the attached television 110, is interrupted.

The standby power controller (SPC) 100 may include any number of Monitored and Controlled outlets 104, which may be monitored and controlled individually or together. The power sensor may monitor the power drawn through all Monitored and Controlled Outlets 104 in aggregate, or may each Monitored and Controlled Outlet 104 individually. Multiple power sensors may be provided.

The standby power controller (SPC) 100 may include a user presence/involvement sensor or similar means to detect that a user is interacting with the audio visual equipment and/or the television. As an example, the sensing and communications unit 113 may include an infra-red sensor 114. This sensor 114 receives IR signals from a remote control associated with the television 110 or other connected AV equipment 112.

It is likely that a user, when actively watching the television 110, will periodically use the remote control to change channels, adjust volume, mute commercials, etc. Thus a remote control signal receiver, such as IR sensor 114, can be used as a user presence and/or involvement sensor. If no remote control activity is detected by the IR sensor 114 for a period of time, the assumption may be made that the television 110 is not in use, either because no user is present, or because any person present is not interested in using the television 110. When this is determined, the television 110 is determined to be in active standby and the power supply to the Monitored and Controlled outlet 104, and hence to the television 110, is interrupted. This may be achieved by using a countdown timer which starts from a specific initial value equal to a particular time period, say one hour, and having this countdown time continuously decrement. Each detected use of the remote control will reset the countdown timer to the initial value. When the countdown time reaches zero, there has been no remote control activity for the time period, and the television 110 is assumed to not be in active use and the electricity supply to the Monitored and Controlled outlet 104, and hence to the television 110, is interrupted.

It may be sufficient to determine that a user is present in the vicinity of the television 110 in order to decide that the television 110 should not be turned off. Any suitable sensor may be used for the user presence/involvement sensor to determine that a user is present and thus that power to the television 110 should not be interrupted. These include, without limitation, passive IR sensors, ultrasonic sensors, cameras, any other passive or active motion sensors, and sound detectors.

Whatever means is used to determine that the television 110 is on, but not in use, it is unlikely to be completely free of false positives, that is, determining that the television 110 is in active standby and not in use when the television 110 is in fact in use. If the television 110 is turned off when a user is still watching a program, the user will be irritated. Repeated occurrences are likely to lead to the user's bypassing the power control function of the standby power controller (SPC) 100, preventing power savings.

A warning LED may also be provided. When the standby power controller (SPC) 100 determines that the television 110 is in active standby, the warning LED may flash to alert any user to the imminent shutdown of the power to the television 110. In the case where there is a false positive, that is, there is a user watching the television 110, the user may react to the flashing of the warning LED by pressing a key on the remote control. The IR signal from the remote control is detected by the IR sensor 114, and the countdown timer is reset, preventing the power to the television 110 being interrupted. Other methods for warning of imminent shutdown of power to the television 110, such as an audible warning tone, may also or alternatively be used.

The standby power controller (SPC) 100 may include software allowing control of the warning mechanism. For example, the brightness of the warning LED may be variable. It may be possible to set times when the warning should take certain forms. For example, an audible warning may be used at certain times of the day, while the warning LED is used at other times. At other times, no warning at all may be given.

Uncontrolled Power Outlets 108, 109 are optionally provided to allow for power to be supplied to devices which should not have the power supply cut when the television 110 is not in use. This Outlet(s) 108, 109 supplies power at all times when the standby power controller (SPC) 100 is plugged in. Any number of Uncontrolled Outlets may be provided.

Devices other than a television 110 may be connected along with a television 110 to the Monitored and Controlled Outlets 104, 105, 106, and 107. In this case, the total load of all devices may be monitored for the characteristics indicating that all devices so connected are in a standby or unused state. This means that only when all devices powered through the Monitored and Controlled Outlets 104, 105, 106, and 107 are determined to be in an unused state will the power be withdrawn.

A third type of power outlet (not shown) may be provided. This non-monitored, controlled outlet is not monitored by the power sensor, so the power drawn by any load connected to the outlet does not contribute to the determination that the monitored load is in a standby or unused state. This outlet is controlled. When power is interrupted to the Monitored and Controlled Outlets 104, 105, 106, and 107, power is also interrupted to this outlet.

The remote communication means (e.g., wi-fi transceiver) 123 provides a data link 125 to an External Communications Unit 126, which may (for example) take the form of a broadband router. In other versions of the invention, the data link 125 may be provided by a Mobile Data Network, such as a 3G or 4G network; a utility provided mesh network; and/or by any suitable wireless protocol, including, without limitation, Bluetooth, ZigBee and Z wave protocols.

The power sensor of the standby power controller (SPC) 100 senses power consumption through each or all Monitored and Controlled Outlets 104, 105, 106, and 107, and outputs this as a power sensor signal, e.g., as power sensor data. Preferably, the sensed power is true RMS power. The data output is used by the SPC 100 to determine when the television 110 has entered a low power standby state. The power sensor signal may also be stored as a data file in memory provided in the SPC 110. The stored data preferably includes the time at which the power consumption sensed by the power sensor occurs. Thus, the power sensor signal may show both the power used by some or all of the appliances powered through the standby power controller (SPC) 100, and the time at which this power use is taking place.

The power sensor signal is transmitted by the data link 125 and the broadband router 126 to a monitoring entity such as an electricity supply utility having an interest in the data defined within the signal. The power sensor signal may be directly transmitted concurrently with its sensing by the power sensor, or the power sensor signal may be transmitted from the memory of the standby power controller (SPC) 100, or both.

The power sensor signal may be used by the utility to determine energy use and time of energy use for appliances in a particular household. The utility may use the power sensor signal to provide information to the household as to ways in which energy can be saved, or ways in which energy costs can be reduced. Where the energy tariff paid by a household varies with time, the energy utility may provide advice to the household that changing the time of use of an appliance can reduce energy costs.

The power sensor signal from a household may be combined with power sensor signals from other households. The power sensor signals allow the utility to study energy use of appliances. Such power sensor signals/data from many households helps the utility to predict future demand. The power sensor signals may also be used to predict the outcome of measures to reduce power consumption, or to encourage householders to move power consumption times in order to smooth peaks in demand. Demand shifting may be encouraged by offering direct demand response programs, where a household is offered an incentive to reduce energy use at a specific time.

The power sensor signal may also be used to monitor the impact of demand response, or other demand reduction or demand shifting strategies.

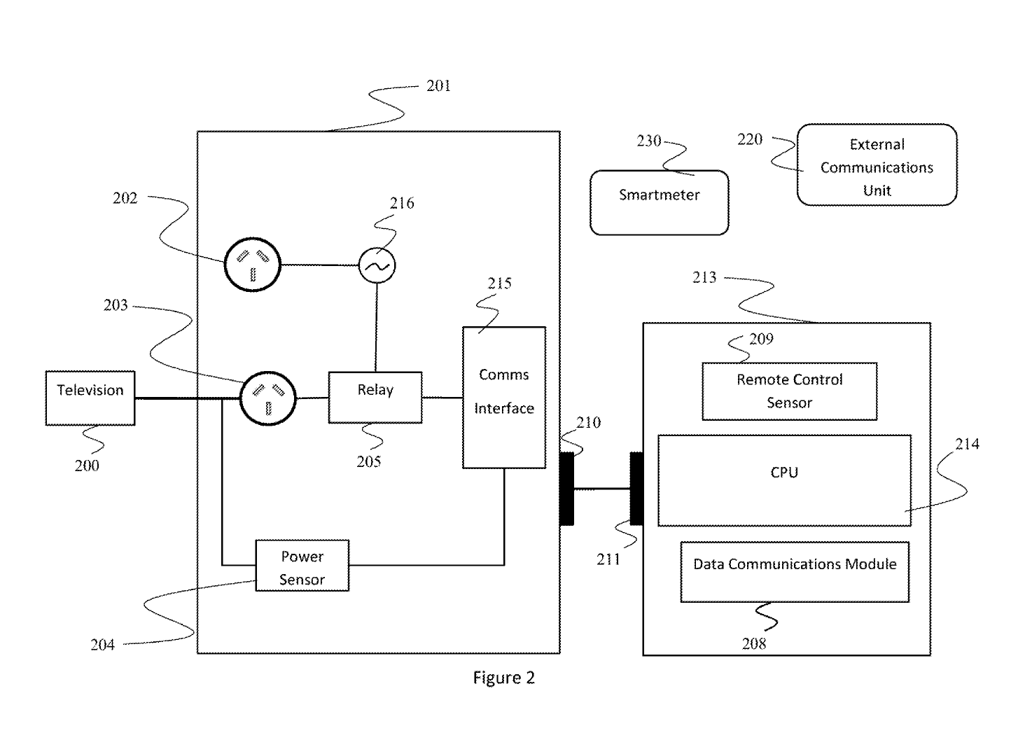

FIG. 2 provides a block diagram representation of a standby power controller (SPC) incorporating the invention. An SPC base 201 supplies power to a television 200, and optionally to other audio visual equipment. A Sensor Unit 213 houses sensors and a CPU 214 which provides the calculation and analytical functionality of the SPC.

The SPC base 201 includes plug connector 210, and the Sensor Unit 213 includes plug connector 211. In the illustrated version of the invention, these connectors 210 and 211 are USB connectors. The SPC base unit 201 and the Sensor Unit 213 are connected by a USB link between these connectors 210 and 211. Any plug-connected wired communications protocol may be used. An advantage of a wired connection is that power can be supplied from the SPC base 201 to the Sensor Unit 213 over such a connection. In this case the Sensor Unit 213 does not need a battery or other independent power supply. In a further version of the invention, the Sensor Unit 213 may have an independent power supply, and the data connection may be provided by a wireless protocol.

The SPC base 201 includes a connection to an external electricity supply 216. Electricity is supplied directly to always-on electricity outlet 202. Electricity is provided via relay 205 to switched and monitored outlet 203, which supplies the electricity to a television 200. The power drawn through the switched and monitored outlet 203 is monitored by power sensor 204. A Communications Interface 215 provides data communication with CPU 214 located in the Sensor Unit 213.

The Sensor Unit 213 includes an external communications device, shown as the Data Communications Module 208. This provides data communication for the CPU 214 to an External Communications Unit 220, e.g., a broadband router. Alternatively or additionally, this data communication functionality may be provided by a Mobile Data Network, such as a 3G or 4G network, or a utility provided mesh network.

The Sensor Unit 213 includes one or more user presence and involvement sensors, such as Remote Control Sensor 209. The Remote Control Sensor 209 senses activity of any appliance remote control unit. In the illustrated version of the invention, the Remote Control Sensor 209 is an infra-red (IR) detector, which is able to detect usage of IR based remote controls. In other versions of the invention the Remote Control Sensor 209 may be a detector for any remote control technology, including without limitation RF4CE communications as used to control many cable television units.

In use, the Remote Control Sensor 209 provides a signal to the CPU 214 concerning use of an IR remote control to control the television 200. The power sensor 204 provides a signal concerning the power state of the television 200 to the CPU 214. Similarly to the version of the invention shown in FIG. 1, the CPU 214 uses this signal to determine when the television 200 has entered a low power standby mode, or is in Active Standby, that is, on but not being actively watched by a user. In either case, the CPU 214 controls the relay 205 to remove the electricity supply from the television 200, saving energy.

When the Remote Control Sensor 209 detects IR indicating that the television 200 is to be turned on, the CPU 214 controls the relay 205 to return electricity supply to the television 200.

Any number of always on outlets 202—including zero—may be provided. One or more switched and monitored outlets 203 may be provided.

The Data Communications Module 208 allows all data collected by the CPU 214 to be communicated to an external monitoring party via the External Communications Unit 220. The operation of the SPC, including calculations of energy saved, may be communicated to the monitoring party.

A device for monitoring the overall electricity use of the household, or a part of the household which includes the SPC installation, is also provided. In FIG. 2, this monitoring device is provided by a Smartmeter 230. In other versions of the invention, the monitoring of overall electricity use may be undertaken by devices which have a purely measuring and communication function, independent of the metering of the electricity supply by a utility. Such devices include, for example, current clamp meters which use sensors which encircle the household electricity supply conductors, and DIN rail meters.

The Smartmeter 230 is in data communication with the external monitoring party. The external monitoring party may be any entity having an interest in the energy use of the household and/or appliances within the household. As examples, this may be an energy supply utility, a demand aggregator, an entity offering energy optimization services, and/or an energy distribution utility.

The monitoring entity may wish to engage in disaggregation of the energy usage of the household. In this case, the monitoring entity receives the signal indicating the total energy usage of the household, or of part of the household. This aggregate usage signal shows the energy usage of all of the electrical devices using energy in the household at a given time. The monitoring entity may wish to separate out the energy usage which may be attributed to each individual appliance. This allows the energy usage of the household to be analyzed, and suggestions made to reduce total or peak energy usage. For example, if it could be determined that a pool pump and an air conditioner were routinely being run together, but that the air conditioner was not run at night it would be possible to recommend that the pool pump usage be moved to the night time in order to reduce the peak usage. When enacted over a large number of households, such changes will allow an energy utility to reduce the peak energy which it must supply, even when the total amount of energy supplied is not varied.

Such disaggregation is difficult to achieve when a number of appliances are being used at the same time. Disaggregation relies on identifying the characteristic signature of a particular type of appliance. A greater number of appliances contributing to the data, and uncertainty about when a particular appliance starts and stops, greatly complicate the disaggregation process.

The Smartmeter 230 communicates an overall electrical usage signal to the monitoring entity. The standby power controller (SPC) communicates the electrical energy usage of the particular appliance or appliances connected to the SPC to the monitoring entity. These two sets of data can be matched in time. The data describing the energy usage of the appliance(s) connected to the SPC can then be subtracted from the overall electrical usage signal/data, leaving the residual electrical usage data. This residual electrical usage data includes components from all appliances in use at the time of collection, except those powered through the SPC. Thus, a reduced number of appliances contribute to the residual electrical usage data, which can then be disaggregated. The reduced number of appliance contributions allows simpler disaggregation.

In a further version of the invention, the Smartmeter 230 is in data communication with the standby power controller (SPC). The Smartmeter 230 communicates the overall electrical usage signal/data to the SPC, which then communicates this overall electrical usage signal/data to the monitoring entity. The Smartmeter 230 may or may not also have a direct data link to the monitoring entity. In a preferred version of the invention, the data link from the Smartmeter 230 to the SPC is a ZigBee protocol link.

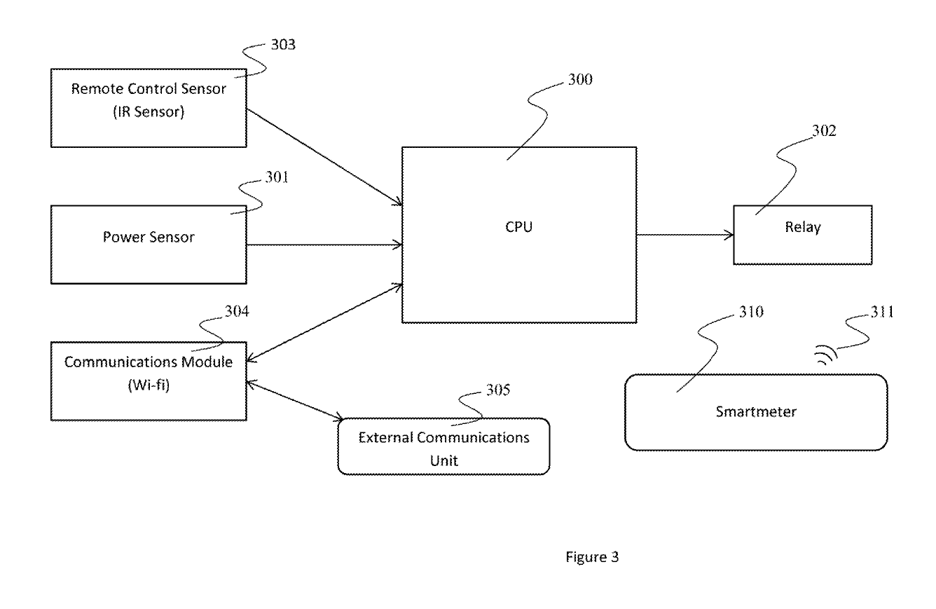

A block diagram of the functions of the standby power controller (SPC) is shown in FIG. 3. In use, the SPC operates to provide power to a television. A CPU 300 is provided which executes commands to provide the analytical functionality of the SPC.

A power sensor 301 monitors the power drawn by the television. The power sensor 301 may monitor the current drawn through the SPC by the television, or both current and voltage may be monitored. Phase angle and/or total RMS power may alternatively or additionally be monitored. The output of the power sensor 301 is provided to the CPU 300.

The monitored power draw is used by the CPU 300 to determine the power state of the television. As an example, a significant drop in the magnitude of the power draw is used to determine that a low power standby mode has been entered. Low power standby is the mode typically entered by a television when switched “off” by remote control. Most functions of the television are halted, but at least sufficient functionality remains to allow the television to be turned “on” by a remote control. Threshold values of power consumption may be used to determine the power state of the television, with any value below a threshold being determined to indicate that the television is in a low power standby power state. Other characteristics of the power use may be used to determine that the television is not in use. This may be the presence, absence or a defined pattern of small fluctuations of the power draw.

The CPU 300 controls one or more relays 302. When the television is determined to be in a standby state, the CPU 300 controls the relay 302 in order to withdraw power from the television and, optionally, associated equipment.

A Remote Control Use sensor 303, e.g., an infra-red (IR) sensor which detects use of infra-red remote control devices, provides data to the CPU 300 indicating use of any remote control. The CPU 300 determines when no remote control activity has been detected for a predetermined period. When this occurs, the CPU 300 provides a warning that the television is about to be shut down, as by flashing the warning LED. If no IR or other remote control activity is detected in response to the warning, the power to the television is interrupted.

While power to the television is interrupted, the Remote Control Use sensor 303 continues to monitor IR or other remote control activity, and send the results to the CPU 300. When the CPU 300 determines that remote control activity has been detected, the relay 302 is operated and thus power is restored to the television.

In a preferred version of the invention, when the power to the television is in the interrupted state, the standby power controller (SPC) will return power to the television when any IR activity is detected. In an alternative version of the invention, the SPC may require that the received IR signal is identified as an “ON” command for the television before returning power to the television. This reduces “false positives” where the SPC reacts to an IR source which is other than the user attempting to turn the television on.

The CPU 300 may be programmed to keep track of the power consumption of the monitored load, both when the load is using full power and when it is in a low power standby state. Information concerning the number of times the power to the load is interrupted may be recorded. Whether the power was interrupted because the television was in a low power standby mode, or because the television was determined to not be in use, may also be recorded. This data may be used to calculate or estimate the energy savings achieved by the standby power controller (SPC).

The standby power controller (SPC) of FIG. 3 includes a Communication Module 304, e.g., a Wi-Fi communication module, though Bluetooth or any other wireless communications protocol may instead or also be used. The Communication Module 304 is in data communication with an External Communications Unit 305. The External Communications Unit 305 allows all data collected by the CPU 300 to be communicated to an external monitoring party. The operation of the SPC, including calculations of energy saved, may therefore be communicated to the monitoring party. The total power drawn through the SPC may also be transmitted to the monitoring party.

A Smartmeter 310 or other device for monitoring the overall electricity use of the household, or a part of the household which includes the SPC installation, is in data communication with the external monitoring party via wireless communications link 311, e.g., a ZigBee mesh network link, mobile data link, or wi-fi link. A wired communications link, including via power line communication, may also or alternatively be provided.

In an exemplary version of the invention, the Smartmeter 310 is in data communication with the Communications Module 304. This data communication may use any suitable wireless protocol, which may be the same protocol used between the Communications Module 304 and the External Communications Unit 305, or a different protocol may be used.

The external monitoring party may be any entity having an interest in the energy use of the household and/or appliances within the household. Without limitation, this may be an energy supply utility, a demand aggregator, an entity offering energy optimization services, and/or an energy distribution utility.

The monitoring party performs data disaggregation to identify individual appliance use within the household. The data from the standby power controller (SPC) is processed with the Smartmeter data to facilitate this disaggregation.

The standby power controller (SPC) may communicate the calculated or estimated energy savings to the monitoring party. Additionally or alternatively, the SPC communicates the raw data from the power sensor 301 and the Remote Control Use sensor 303, along with the timing of the relay control activity, to the monitoring party via the External Communications Unit 305.

A major cause of failure to save power by standby power controllers (SPCs) is de-installation when a user finds the action of the SPC to be intrusive or annoying, and simply removes the SPC, preventing any energy savings. False detection of Active Standby, and subsequent cutting of power to the television while it is in use, is a major cause of this failure.

The standby power controller (SPC) may also report the frequency of use of the remote control to the monitoring entity. The monitoring entity may also collect information on how often and at what times the user uses the remote control to prevent the SPC removing power from the television after a warning has been given. These are occasions when the SPC has determined incorrectly that the television is in Active Standby when a user is still actively watching the television. This information may be used to determine a more accurate pattern which indicates that the television is in fact in Active Standby, allowing less occasions where the SPC attempts to (or does) cut power to a television in active use. Improvements in the determination of Active Standby reduce user de-installation.

Where the foregoing discussion refers to infra-red remote controls and corresponding infra-red sensors, it will be understood that any form of remote control and corresponding sensors, including (for example) radio frequency remote controls, may be employed. Similarly, where wi-fi is identified as the communication mode between the standby power controller (SPC) and the monitoring party, it should be understood that any suitable wired or wireless communications means or protocol may be used.

The invention is not limited to the exemplary versions of the invention described above, but rather is intended to be limited only by the claims set out below. Thus, the invention encompasses all different versions that fall literally or equivalently within the scope of these claims.

What is claimed is:

1. A standby power controller including:
a. a power sensor configured to provide a power sensor signal indicative of power drawn through the standby power controller;
b. a user presence/involvement sensor configured to provide a user presence/involvement signal indicative of whether a television powered by the standby power controller is in an active standby mode;
d. a switch configured to remove power from the television powered by the standby power controller if:
(1) the power sensor signal is indicative of a device powered by the standby power controller being in a low power standby power state, and/or
(2) the user presence/involvement signal is indicative of the television being in the active standby mode; and
e. an external communications unit configured to transmit the power sensor signal to an external monitoring agent.

2. The standby power controller of claim 1 wherein the user presence/involvement sensor is configured to generate the user presence/involvement signal by detecting use of a remote control which controls a device powered by the standby power controller.

3. The standby power controller of claim 2 wherein the user presence/involvement sensor is an infra-red detector configured to detect use of an infra-red remote control device.

4. The standby power controller of claim 2 wherein the user presence/involvement sensor is a radio frequency radiation detector configured to detect use of a radio frequency remote control device.

5. The standby power controller of claim 1 wherein the user presence/involvement sensor is a motion sensor.

6. The standby power controller of claim 1 wherein the user presence/involvement sensor further includes a sensor configured to detect usage of a remote control.

7. The standby power controller of claim 1 further including a wireless transceiver in communication with a Smartmeter.

8. The standby power controller of claim 1 wherein:
a. the external communications unit is defined by a household wi-fi router, and
b. the standby power controller further includes a wi-fi communications transceiver configured to communicate with the external communications unit.

9. The standby power controller of claim 1 wherein the standby power controller further includes a low power cellular telephony communications transceiver configured to communicate with the external communications unit.

10. An energy usage monitoring system including the standby power controller of claim 1, further including a power measurement device configured to:
a. provide an overall power usage signal indicative of overall power drawn by at least a part of a household where the standby power controller is installed, and
b. communicate the overall power usage signal to the external monitoring agent.

11. The energy usage monitoring system of claim 10 wherein the power measurement device is a meter configured to provide a household power usage measurement, the household power usage measurement defining utility charges for energy use.

12. The energy usage monitoring system of claim 10 wherein the power measurement device is a meter independent of any meter which measures household power usage measurement defining utility charges for energy use.

13. The energy usage monitoring system of claim 10 further including a processor configured to process the power sensor signal with the overall power usage signal to disaggregate the power use of at least one appliance whose power use is included in the overall power usage signal but not in the power sensor signal.

14. A method of disaggregating energy use by a household using the standby power controller of claim 1, the method including the steps of:
a. receiving data from a power measurement device configured to provide an overall power usage signal indicative of overall power drawn by at least a part of a household where the standby power controller is installed; and
b. processing the power sensor signal with the overall power usage signal to disaggregate the power use of at least one appliance whose power use is included in the overall power usage signal but not in the power sensor signal.
